(19) United States
(12) Patent Application Publication
(10) Pub. No.: US 2023/0030967 A1
(43) Pub. Date: Feb. 2, 2023

(54) STORAGE DEVICE AND METHOD FOR CONTROLLING STORAGE DEVICE

(71) Applicant: SHENZHEN SKYWORTH-RGB ELECTRONIC CO., LTD., Shenzhen (CN)

(72) Inventor: Shengyang DENG, Shenzhen (CN)

(73) Assignee: SHENZHEN SKYWORTH-RGB ELECTRONIC CO., LTD., Shenzhen (CN)

(21) Appl. No.: 17/873,525

(22) Filed: Jul. 26, 2022

(30) Foreign Application Priority Data
Jul. 27, 2021 (CN) 202110864776.8

(51) Int. Cl. G06F 3/06

(52) U.S. Cl. CPC G06F 3/0643; G06F 3/0659

(57) ABSTRACT

Disclosed are a storage device and a method for controlling a storage device. When the storage device is inserted into a control device, in response to receiving an instruction of insertion, the operating system is configured to loads a system to enter a working mode; the communication module is configured to receive a to-be-written file from a terminal device and the operating system module is configured to write the to-be-written file into the storage module, to make the control device read a storage file stored in the storage module.

### CROSS-REFERENCE TO RELATED APPLICATIONS

This application claims priority to Chinese Patent Application No. 202110864776.8, filed on Jul. 27, 2021. The disclosures of the aforementioned application are incorporated herein by reference in its entirety.

### TECHNICAL FIELD

The present disclosure relates to the technical field of storage devices, in particular to a storage device and a method for controlling a storage device.

### BACKGROUND

At present, as a common portable storage device, the USB flash disk is easy to be used. However, in some scenarios where the USB flash disk needs to be frequently plugged and unplugged to exchange data, or where the storage device is installed in a closed or hidden location, there are also some limitations when using the USB flash disk, which is not convenient enough for the user. For example, in the debugging process based on the Android smart TV, as a transfer medium for installation and extraction information of computer and Android TV application, the USB flash disk needs to be frequently plugged and unplugged between the smart TV and the computer to exchange data. As an ordinary configuration of a car, the USB flash disk is useful to store songs. However, if users want to update the media content of the USB flash disk, they need to remove the USB flash disk, and then update the media content through a computer or other devices, which is inconvenient for the users. Therefore, the storage device in the related art is inconvenient for the users to use since it needs to be frequently plugged and unplugged to exchange data.

The foregoing description is to provide general background information and does not necessarily constitute prior art.

### SUMMARY

The present disclosure provides a storage device and a method for controlling a storage device, which aims to solve the problem that in the related art the storage device is inconvenient for the users to use since it needs to be frequently plugged and unplugged to exchange data.

In order to achieve the above objective, the present disclosure provides a storage device, including a storage module, an operating system module, and a communication module. The storage device is inserted into a control device. In response to receiving an insertion instruction, the operating system module is configured to load a system according to the insertion instruction to enter a working mode; and the communication module is configured to remotely receive a to-be-written file from a terminal device and the operating system module is configured to write the to-be-written file into the storage module, to make the control device read a storage file stored in the storage module.

In an embodiment, in response that the to-be-written file is a control script, the operating system module is further configured to control the control device to load the control script and obtain a target file information; and the communication module is further configured to send the target file information written into the storage module by the operating system module to the terminal device.

In an embodiment, the operating system module is further configured to recognize a use state of the control script; and in response that the control script is in a used state, the operating system module is further configured to obtain the target file information.

In an embodiment, the communication module includes a wireless communication module and a mobile communication module; the communication module is further configured to determine a target remote communication module from the wireless communication module and the mobile communication module; the communication module is further configured to remotely receive the to-be-written file from the terminal device through the target remote communication module; the operating system module is further configured to determine a target operation instruction according to the control script and a preset operation instruction when the to-be-written file is the control script; the operating system module is further configured to determine a target file type according to the target operation instruction and a preset file type;

and the operating system module is further configured to control the control device to load the control script according to the target file type, and obtain the target file information.

In an embodiment, the communication module is configured to determine a target remote communication module according to a network connection relationship between the terminal device and the control device.

In an embodiment, the communication module is further configured to remotely receive the to-be-written file from the terminal device; and in response that the to-be-written file is an update file, the operating system module is configured to write a parameter information corresponding to the update file into the storage module, to make the control device read the parameter information stored in the storage module to update data of the storage device.

In an embodiment, the storage device further includes a USB interface; the operating system module is further configured to pack the storage file stored in the storage module according to a type of the USB interface and a data transmission format corresponding to the communication module to obtain a target data package; and the communication module is further configured to send the target data package to the terminal device.

In an embodiment, the operating system module is configured to determine the data transmission format according to a communication protocol corresponding to the communication module.

In an embodiment, the communication module is further configured to remotely receive the to-be-written file from the terminal device via a current network signal, and the operating system module is configured to write the to-be-written file into the storage module, to make the control device read the storage file stored in the storage module.

In an embodiment, when the current network signal connecting the terminal device to the storage device is stable, the communication module is configured to remotely receive the to-be-written file from the terminal device; and when the current network signal is unstable, the communication module is configured to temporarily stop receiving the to-be-written file from the terminal device.

In addition, in order to achieve the above objective, the present disclosure further provides a method for controlling a storage device, applied to a system for controlling the storage device, the system for controlling the storage device includes a storage device; the storage device includes a storage module, an operating system module and a communication module; and the method for controlling the storage device includes following operations: in response to receiving an insertion instruction, loading, by the operating system module, a system according to the insertion instruction to enter a working mode; and remotely receiving, by the communication module, a to-be-written file from the terminal device; and writing, by the operating system module, the to-be-written file into the storage module to make the control device read a storage file in the storage module.

In an embodiment, after the operation of remotely receiving, by the communication module, the to-be-written file from the terminal device, and writing, by the operating system module, the to-be-written file into the storage module, to make the control device read the storage file stored in the storage module, the method further includes: controlling, by the operating system module, the control device to load the control script and obtaining a target file information, in response that the to-be-written file is a control script; and sending, by the communication module, the target file information written into the storage module by the operating system module to the terminal device.

In an embodiment, the operation of controlling, by the operating system module, the control device to load the control script and obtaining the target file information, in response that the to-be-written file is the control script includes: recognizing, by the operating system module, a use state of the control script; and obtaining, by the operating system module, the target file information in response that the control script is in a used state.

In an embodiment, the communication module includes a wireless communication module and a mobile communication module; the operation of recognizing, by the operating system module, the use state of the control script; and obtaining, by the operating system module, the target file information in response that the control script is in the used state includes: determining, by the communication module, a target remote communication module from the wireless communication module and the mobile communication module; remotely receiving, by the communication module, the to-be-written file from the terminal device through the target remote communication module; determining, by the operating system module, a target operation instruction according to the control script and a preset operation instruction when the to-be-written file is the control script; determining, by the operating system module, a target file type according to the target operation instruction and a preset file type; and controlling, by the operating system module, the control device to load the control script according to the target file type, and obtaining the target file information.

In an embodiment, after the operation of remotely receiving, by the communication module, the to-be-written file from the terminal device, and writing, by the operating system module, the to-be-written file into the storage module, to make the control device read the storage file stored in the storage module, the method further includes: remotely receiving, by the communication module, the to-be-written file from the terminal device; and in response that the to-be-written file is an update file, writing, by the operating system module, a parameter information corresponding to the update file into the storage module, to make the control device read the parameter information stored in the storage module to update data of the storage device.

In an embodiment, the storage device further includes a USB interface; after the operation of remotely receiving, by the communication module, the to-be-written file from the terminal device, and writing, by the operating system module, the to-be-written file into the storage module, to make the control device read the storage file stored in the storage module, the method further includes: packing, by the operating system module, the storage file stored in the storage module according to a type of the USB interface and a data transmission format corresponding to the communication module to obtain a target data package; and sending, by the communication module, the target data package to the terminal device.

In an embodiment, the operation of remotely receiving, by the communication module, the to-be-written file from the terminal device, and writing, by the operating system module, the to-be-written file into the storage module, to make the control device read the storage file stored in the storage module further includes: remotely receiving, by the communication module, the to-be-written file from the terminal device via a current network signal, and writing, by the operating system module, the to-be-written file into the storage module, to make the control device read the storage file stored in the storage module.

The present disclosure provides a storage device and a method for controlling a storage device. In response to receiving an insertion instruction, the operating system is configured to load a system according to the insertion instruction to enter a working mode; the communication module is configured to remotely receive a to-be-written file from a terminal device and the operating system module is configured to write the to-be-written file into the storage module, to make the control device read a storage file stored in the storage module. In the present disclosure, the operating system module of the storage device writes the to-be-written file into the storage module, such that the control device can read the storage file stored in the storage module, and the terminal device can remotely access the control device. In the related art, the storage device needs to be frequently plugged and unplugged to exchange data, however, in the present disclosure, the terminal device can perform remote communication access and data interaction to the control device without plugging or unplugging the storage device.

### BRIEF DESCRIPTION OF THE DRAWINGS

In order to more clearly illustrate the embodiments of the present disclosure, drawings used in the embodiments will be briefly described below. Obviously, the drawings in the following description are only some embodiments of the present disclosure. It will be apparent to those skilled in the art that other figures can be obtained according to the structures shown in the drawings without creative work.

FIG. 1 is a schematic structural diagram of a storage device according to an embodiment of the present disclosure.

FIG. 2 is a schematic flowchart of a smart TV control process according to an embodiment of the present disclosure.

FIG. 3 is a schematic flowchart of a method for controlling a storage device according to an embodiment of the present disclosure.

The realization of the objective, functional characteristics, and advantages of the present disclosure are further described with reference to the accompanying drawings.

### DETAILED DESCRIPTION OF THE EMBODIMENTS

It should be understood that the specific embodiments described herein are only used to explain the present disclosure, and are not intended to limit the present disclosure.

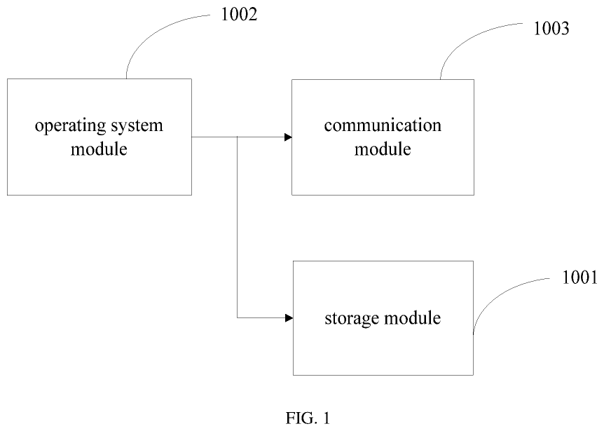

As shown in FIG. 1, FIG. 1 is a schematic structural diagram of a storage device according to an embodiment of the present disclosure.

As shown in FIG. 1, the storage device may include a storage module 1001, an operating system module 1002 and a communication module 1003.

Those skilled in the art should understand that the structure of the terminal shown in FIG. 1 does not limit the terminal, and the terminal may include more or fewer components than shown in FIG. 1, a combination of some components, or differently arranged components shown in FIG. 1.

The present disclosure provides a storage device.

In this embodiment, the storage device includes a storage module 1001, an operating system module 1002 and a communication module 1003 and the storage device is inserted into a control device. In response to receiving an insertion instruction, the operating system module 1002 is configured to load a system according to the insertion instruction to enter a working mode

It should be noted that the storage device is a device which may be inserted into the control device, such as a universal serial bus (USB) flash disk, and the storage module 1001 may refer to a module for storing data in the storage device, such as a storage module 1001 in the USB flash disk.

It may be understood that the insertion instruction may refer to an instruction signal generated when the storage device is inserted into the control device. Loading a system may mean loading the system in the storage device when the operating system module 1002 of the storage device receives the insertion instruction, and the working mode may refer to the working mode determined after the system is loaded.

In an embodiment, upon receiving the insertion instruction generated when the storage device is inserted into the control device, the operating system module 1002 loads the system according to the insertion instruction to enter the working mode.

The communication module 1003 is configured to remotely receive a to-be-written file from a terminal device and the operating system module 1002 is configured to write the to-be-written file into the storage module 1001, to make the control device read a storage file stored in the storage module 1001.

It should be noted that the terminal device may refer to a device that remotely accesses the storage device, and the terminal device may be a local computer or other device using the storage device to remotely transmit and update data, which is not limited in this embodiment.

It is understandable that the to-be-written file may refer to a file which needs to be written into the storage device, and the file may be a resource file including parameter information, script information, and debugging information, which is not limited in this embodiment.

It should be understood that the control device may refer to a device connected to the storage device, and the control device may refer to a device requiring data transmission and update. The storage file may refer to a storage file stored in the storage module 1001. The storage file may be a storage file generated after the to-be-written file is stored in the storage module 1001, or may be a historical storage file, and the historical storage file may be a resource file uploaded to the terminal device, such as resource files including parameter information, log information, debugging information or other information.

In an embodiment, the communication module 1003 is configured to remotely receive a to-be-written file from a terminal device and the operating system module 1002 is configured to write the to-be-written file into the storage module 1001, to make the control device read a storage file stored in the storage module 1001.

In this embodiment, when the storage device is inserted into the control device, in response to receiving an insertion instruction, the operating system module 1002 is configured to load a system according to the insertion instruction to enter a working mode; and the communication module 1003 is configured to remotely receive a to-be-written file from a terminal device and the operating system module 1002 is configured to write the to-be-written file into the storage module 1001, to make the control device read a storage file stored in the storage module 1001. In the present disclosure, the operating system module 1002 of the storage device writes the to-be-written file into the storage module 1001, such that the control device can read the storage file stored in the storage module 1001, and the terminal device can remotely access the control device. In the related art, the storage device needs to be frequently plugged and unplugged to exchange data, however, in this embodiment, the terminal device can perform remote communication access and data interaction to the control device without plugging or unplugging the storage device.

The present disclosure further provides a storage device.

In this embodiment, in response that the to-be-written file is a control script, the operating system module 1002 is further configured to control the control device to load the control script and obtain a target file information.

It should be noted that the control script may refer to a control script for controlling a software application, the script may be saved in text, and may be interpreted or compiled when called. The control script may also be a script language for controlling the operation of the control script.

It is understandable that the target file information may refer to a file information generated after the control device loads the control script. The file information may include log information, advertisement information, media information, and other information. The log information may be the operating condition information generated when the control device is running, that is to say, the log information may be a log file or a set of files in which the control device records the system operation events and may be divided into the event log and the message log. The log information generated by different control devices is different, and the log information is not limited in this embodiment. For example, when the control device is a smart TV, the log information may be screen use state information or parameter information of the smart TV when the smart TV fails, which is not limited in this embodiment.

It should be understood that advertisement information may refer to the content that needs to be delivered to the audience, and the content of advertisement information may be in various forms, including text, images, audio, and video, or the like that can be perceived by people. Media information may refer to product information of an object carrying multimedia information, and may also be information of entities used to store, present, process and transmit information.

In an embodiment, in response that the to-be-written file is a control script, the operating system module 1002 is further configured to control the control device to load the control script and obtain a target file information.

The communication module 1003 is further configured to send the target file information written into the storage module 1001 by the operating system module 1002 to the terminal device.

It should be noted that the operating system module 1002 determine a to-be-extracted file information from the file information set of the control device according to the control script, and the to-be-extracted file information is used as the target file information.

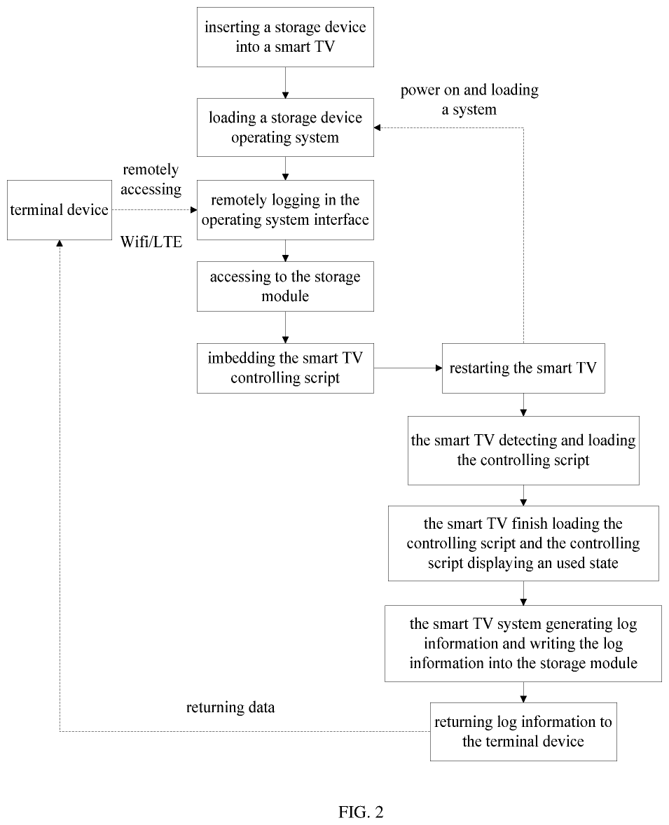

In an embodiment, the communication module 1003 is further configured to send the target file information written into the storage module 1001 by the operating system module 1002 to the terminal device. For further explanation, as shown in FIG. 2, FIG. 2 is a schematic flowchart of a smart TV control process according to an embodiment of the present disclosure. In the field of android smart TV testing, in order to solve the current problem of capturing the TV log information, when debugging the TV during the development of the TV function software, the tester needs to obtain the debugging log information through the USB device, and then send the log information to the relevant development platform or terminal device through WeChat or email for technical analysis. Therefore, when the storage device is inserted into the control device, in response to receiving the insertion instruction, the operating system module 1002 loads the system according to the insertion instruction to enter the working mode; the terminal device may access the communication module 1003 of the storage device through communication technologies such as WIFI/LET, and log into the system control interface remotely. The communication module 1003 of the storage device may remotely receive the to-be-written file from the terminal device, and the operating system module 1002 may write the to-be-written file into the storage module 1001. In this way, the smart TV may read the file stored in the storage module 1001 and then restart according to the control script. Meanwhile, the smart TV loads the control script. When the smart TV finishes loading the script, the script is updated to the used state, the smart TV generates log information corresponding to the control script, the operating system module 1002 writes the log information into the storage module 1001, and the communication module 1003 transmits the target file information to the terminal device.

Further, in order to improve the operating efficiency of the system, the operating system module 1002 is further configured to recognize a use state of the control script; and in response that the control script is in a used state, the operating system module 1002 is further configured to obtain the target file information.

It should be noted that the use state of the control script may refer to the state of the control script loaded by the control device, and the loading state may be divided into three states: unloading, loading, and loading completed. That is to say, the use state may be determined according to the loading state.

In an embodiment, in order to improve the operation efficiency of the system, the operating system module 1002 may determine whether the control device generates the target file information by identifying the use state of the control script. When the control script is in the used state, it is determined that the control device finishes loading the control script and the control script is updated to the used state, the operating system module 1002 obtains the target file information.

Further, in order to meet different remote control requirements and improve remote access capability, the communication module 1003 includes a wireless communication module and a mobile communication module. The communication module 1003 is further configured to determine a target remote communication module from the wireless communication module and the mobile communication module. The communication module 1003 is further configured to remotely receive the to-be-written file from the terminal device through the target remote communication module. The operating system module 1002 is further configured to determine a target operation instruction according to the control script and a preset operation instruction when the to-be-written file is the control script. The operating system module 1002 is further configured to determine a target file type according to the target operation instruction and a preset file type. The operating system module 1002 is further configured to control the control device to load the control script according to the target file type, and obtain the target file information.

It should be noted that the wireless communication module may support GPRS and short message dual-channel data transmission, multi-center data communication, and remote parameter setting and program upgrade. The wireless communication module may also communicate through a wireless local area network, for example, by connecting to WIFI for networking, the wireless communication module realizes long-distance communication. The mobile communication module may refer to a module for data transmission based on the standard of universal mobile communication technology in the long-term evolution, for example, a module with mobile communication technologies such as 3G, 4G, and 5G.

It may be understood that the target remote communication module may be a module determined from the communication module 1003 according to the network connection relationship between the terminal device and the control device. The preset operation instruction may be an operation instruction preset in advance. Different control devices have different preset operation instructions, and different control scripts have different operation instructions. The target operation instruction may be an operation instruction determined according to the corresponding relationship between the preset operation instruction and the control script.

It should be understood that the preset file type may be a file type generated by the control device in advance, that is, different control devices generate different file types, and the file types generated by the same control device may also be different. For example, the file type generated by a smart TV may be a log type, and the log type may be further divided into operating condition log, fault event log, and fault processing log. This embodiment does not limit the log type, and the target file type may be a file type determined from the preset file types according to the target operation instruction. For example, the file type may be a fault event log of a smart TV.

It should be understood that the control device may be controlled by the determined target file type to load the control script, so as to obtain the target file information. That is, in order to improve the accuracy of obtaining the file information, the to-be-extracted file information may be accurately determined according to the target file type. The control device obtains the to-be-extracted file information according to the control script, and then outputs the to-be-extracted file information as the target file information.

In an embodiment, in order to improve remote access capability, the communication module 1003 includes a wireless communication module and a mobile communication module. The communication module 1003 is further configured to determine a target remote communication module 1003 from the wireless communication module and the mobile communication module. The communication module 1003 is further configured to remotely receive the to-be-written file from the terminal device through the target remote communication module 1003. The operating system module 1002 is further configured to determine a target operation instruction according to the control script and a preset operation instruction when the to-be-written file is the control script. The operating system module 1002 is further configured to determine a target file type according to the target operation instruction and a preset file type. The operating system module is further configured to control the control device to load the control script according to the target file type, and obtain the target file information.

Further, in order to improve the data update efficiency in the control device, the communication module 1003 is further configured to remotely receive the to-be-written file from the terminal device. In response that the to-be-written file is an update file, the operating system module 1002 is configured to write a parameter information corresponding to the update file into the storage module 1001, to make the control device read the parameter information stored in the storage module 1001 to update data of the storage device.

It should be noted that the update file may be a file for updating the script, or a resource file for updating the parameter information. The specific content of the update file is not limited in this embodiment. .

In an embodiment, in the field of TV or outdoor advertising screens, it is necessary to update the played video content irregularly. Managerial staffs may remotely access and update the resource files stored in the storage device (such as the resource files stored in a USB flash disk) through 5G communication and other ways, to remotely manage and update playback content. Or, in the field of traditional numerical control machining (CNC), the storage device is used in the processing device, the processing data parameters may be imported into the machine remotely, to transmit and update the processing data in real time.

Further, in order to ensure the efficiency of data transmission, the storage device further includes a USB interface. The operating system module 1002 is further configured to pack the storage file stored in the storage module 1001 according to a type of the USB interface and a data transmission format corresponding to the communication module 1003 to obtain a target data package. The communication module 1003 is further configured to send the target data package to the terminal device.

It should be noted that the USB interface may be a power supply interface or a communication interface. The communication interface may refer to a serial port used to connect a computer system to an external device. This embodiment does not limit the interface type.

It is understandable that different communication modules 1003 have different data transmission formats, and the data transmission format may be determined according to a communication protocol corresponding to the communication module 1003.

In an embodiment, in order to ensure safely and efficiently transmit the remote data, the operating system module 1002 is further configured to pack the storage file stored in the storage module 1001 according to a type of the USB interface and a data transmission format corresponding to the communication module 1003 to obtain a target data package. The communication module 1003 is further configured to send the target data package to the terminal device. For example, in the field of android smart TV testing, the TV will be debugged during the development of the TV function software. The tester needs to obtain the debugging log information through the USB device, and then send the log information to the relevant development platform or terminal device through WeChat or email for technical analysis. That is, in this embodiment, the files stored in the USB flash disk may be accessed wirelessly or remotely. The log information stored in the storage module 1001 may be packed according to the type of the USB interface in the storage device and the data transmission format corresponding to the communication protocol of the communication module 1003 to obtain the target data package. The communication module 1003 sends the target data package to the terminal device, which improve the efficiency and security of the data transmission.

Further, the communication module 1003 is further configured to remotely receive the to-be-written file from the terminal device via a current network signal, and the operating system module 1002 is configured to write the to-be-written file into the storage module 1001, to make the control device read the storage file stored in the storage module 1001.

It should be noted that the current communication network signal may refer to a network signal connecting the terminal device to the storage device.

In an embodiment, the communication module 1003 is configured to remotely receive the to-be-written file from the terminal device via a current network signal, and the operating system module 1002 is configured to write the to-be-written file into the storage module 1001, to make the control device read the storage file stored in the storage module 1001. For example, when the current network signal connecting the terminal device to the storage device is stable, the communication module is configured to remotely receive the to-be-written file from the terminal device, and when the current network signal is unstable, the communication module is configured to temporarily stop receiving the to-be-written file from the terminal device to avoid losing the to-be-written file.

In this embodiment, when the storage device is inserted into the control device, in response to receiving the insertion instruction, the operating system module 1002 is configured to load the system according to the insertion instruction to enter the working mode; and the communication module 1003 is configured to remotely receive the to-be-written file from the terminal device and the operating system module 1002 is configured to write the to-be-written file into the storage module 1001, to make the control device read the storage file stored in the storage module 1001. In response that the to-be-written file is the control script, the operating system module 1002 is further configured to control the control device to load the control script and obtain the target file information; and the communication module 1003 is further configured to send the target file information written into the storage module 1001 by the operating system module 1002 to the terminal device. In the related art, the storage device needs to be frequently plugged and unplugged to exchange data, however, in this embodiment, the terminal device can perform remote communication access and data interaction to the control device without plugging or unplugging the storage device.

Based on the above storage device, the present disclosure further provides a method for controlling a storage device.

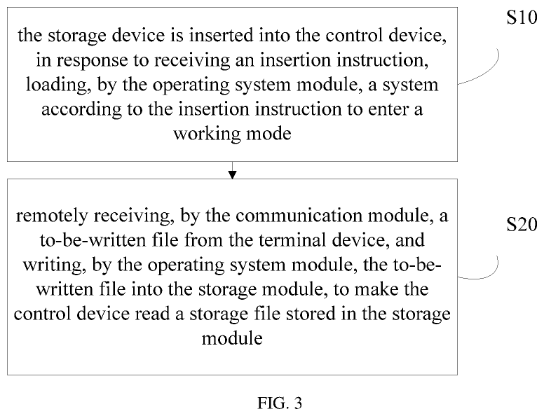

As shown in FIG. 3, FIG. 3 is a schematic flowchart of a method for controlling a storage device according to an embodiment of the present disclosure.

In this embodiment, the method for controlling a storage device includes following operations:

Operation S10, the storage device is inserted into the control device, in response to receiving an insertion instruction, loading, by the operating system module 1002, a system according to the insertion instruction to enter a working mode.

It should be noted that the storage device is a device which may be inserted into the control device, such as a USB flash disk, and the storage module 1001 may refer to a module for storing data in the storage device, such as a storage module 1001 in the USB flash disk.

It may be understood that the insertion instruction may refer to an instruction signal generated when the storage device is inserted into the control device. Loading a system may mean loading the system in the storage device when the operating system module 1002 of the storage device receives the insertion instruction, and the working mode may refer to the working mode determined after the system is loaded.

In an embodiment, upon receiving the insertion instruction generated when the storage device is inserted into the control device, the operating system module 1002 loads the system according to the insertion instruction to enter the working mode.

Operation S20, remotely receiving, by the communication module 1003, a to-be-written file from the terminal device, and writing, by the operating system module 1002, the to-be-written file into the storage module 1001, to make the control device read a storage file stored in the storage module 1001.

It should be noted that the terminal device may refer to a device that remotely accesses the storage device, and the terminal device may be a local computer or other device using the storage device to remotely transmit and update data, which is not limited in this embodiment.

It is understandable that the to-be-written file may refer to a file which needs to be written into the storage device, and the file may be a resource file including parameter information, script information, and debugging information, which is not limited in this embodiment.

It should be understood that the control device may refer to a device connected to the storage device, and the control device may refer to a device requiring data transmission and update. The storage file may refer to a storage file stored in the storage module 1001. The storage file may be a storage file generated after the to-be-written file is stored in the storage module 1001, or may be a historical storage file, and the historical storage file may be a resource file uploaded to the terminal device, such as resource files including parameter information, log information, debugging information or other information.

In an embodiment, the communication module 1003 is configured to remotely receive a to-be-written file from a terminal device and the operating system module 1002 is configured to write the to-be-written file into the storage module 1001, to make the control device read a storage file stored in the storage module 1001.

Further, after the operation S20, the method for controlling the storage device further includes following operations: controlling, by the operating system module 1002, the control device to load the control script and obtaining a target file information, in response that the to-be-written file is a control script; and sending, by the communication module 1003, the target file information written into the storage module 1001 by the operating system module 1002 to the terminal device.

It should be noted that the control script may refer to a control script for controlling a software application, the script may be saved in text, and may be interpreted or compiled when called. The control script may also be a script language for controlling the operation of the control script.

It is understandable that the target file information may refer to a file information generated after the control device loads the control script. The file information may include log information, advertisement information, media information, and other information. The log information may be the operating condition information generated when the control device is running, that is to say, the log information may be a log file or a set of files in which the control device records the system operation events and may be divided into the event log and the message log. The log information generated by different control devices is different, and the log information is not limited in this embodiment. For example, when the control device is a smart TV, the log information may be screen use state information or parameter information of the smart TV when the smart TV fails, which is not limited in this embodiment.

It should be understood that advertisement information may refer to the content that needs to be delivered to the audience, and the content of advertisement information may be in various forms, including text, images, audio, and video, or the like that can be perceived by people. Media information may refer to product information of an object carrying multimedia information, and may also be information of entities used to store, present, process and transmit information.

It should be noted that the operating system module 1002 determine a to-be-extracted file information from the log information set corresponding to the control device according to the control script, and the to-be-extracted file information is used as the target file information.

In an embodiment, in response that the to-be-written file is a control script, the operating system module 1002 is further configured to control the control device to load the control script and obtain a target file information. The communication module 1003 is further configured to send the target file information written into the storage module 1001 by the operating system module 1002 to the terminal device.

The storage device further includes a USB interface; after the operation S20, the method for controlling the storage device further includes following operations: packing, by the operating system module 1002, the storage file stored in the storage module 1001 according to a type of the USB interface and a data transmission format corresponding to the communication module 1003 to obtain a target data package; and sending, by the communication module 1003, the target data package to the terminal device.

It should be noted that the USB interface may be a power supply interface or a communication interface which may refer to a serial port used to connect a computer system and an external device. This embodiment does not limit the interface type.

It is understandable that different communication modules 1003 have different data transmission formats, and the data transmission format may be determined according to a communication protocol corresponding to the communication module 1003.

In an embodiment, in order to ensure the safely and efficiently transmit the remote data, the operating system module 1002 may pack the files storage stored in the storage module 1001 according to a type of the USB interface in the storage device and the data transmission format corresponding to a communication protocol of the communication module 1003 to obtain a target data package. The communication module 1003 sends the target data package to the terminal device. For example, in the field of android smart TV testing, the TV will be debugged during the development of the TV function software. The tester needs to obtain the debugging log information through the USB device, and then send the log information to the relevant development platform or terminal device through WeChat or email for technical analysis. That is, in this embodiment, the files stored in the USB flash disk may be accessed wirelessly or remotely. The log information stored in the storage module 1001 may be packed according to the type of the USB interface in the storage device and the data transmission format corresponding to the communication protocol of the communication module 1003 to obtain the target data package, the communication module 1003 sends the target data package to the terminal device, which improve the efficiency and security of the data transmission.

In this embodiment, in response to receiving the insertion instruction, the operating system module 1002 is configured to load the system according to the insertion instruction to enter the working mode. The communication module 1003 is configured to remotely receive the to-be-written file from the terminal device and the operating system module 1002 is configured to write the to-be-written file into the storage module 1001, to make the control device read the storage file stored in the storage module 1001. In response that the to-be-written file is the control script, the operating system module 1002 is further configured to control the control device to load the control script and obtain the target file information, and the communication module 1003 is further configured to send the target file information written into the storage module 1001 by the operating system module 1002 to the terminal device. In the related art, the storage device needs to be frequently plugged and unplugged to exchange data, however, in this embodiment, the terminal device can perform remote communication access and data interaction to the control device without plugging or unplugging the storage device.

Furthermore, it should be noted that, herein, the terms “include”, “including” or any other variations thereof are intended to encompass non-exclusive inclusions, so that a process, method, article or system literally including a series of elements includes not only those elements, but also other elements not expressly listed or inherent to such a process, method, article or system. Without further limitation, an element qualified by the phrase “including a . . . ” does not preclude the existence of additional identical elements in the process, method, article or system that includes the element.

The above-mentioned serial numbers of the embodiments of the present disclosure are only for description, and do not represent the advantages or disadvantages of the embodiments.

From the description of the above embodiments, those skilled in the art can clearly understand that the methods of the above embodiments can be implemented not only by means of a software plus a necessary general hardware platform, but also by means of a hardware. However in many cases the former is better. Based on this understanding, the technical solutions of the present disclosure in essence or the parts that make contributions to the prior art can be embodied in the form of software products. The computer software products is stored in a storage medium (such as a read-only memory/random access memory, a magnetic disk or an optical disk, etc.), and includes several instructions to make a terminal device (such as a mobile phone, a computer, a server, or a network device, etc.) execute the methods described in the various embodiments of the present disclosure.

Although the embodiments of the present disclosure have been shown and described above, the scope of the present disclosure is not limited thereto. It can be understood that the above-mentioned embodiments are exemplary and cannot be understood as a limitation of the present disclosure. Those of ordinary skill in the art can make changes, modifications and substitutions to the above-mentioned embodiments within the scope of the present disclosure, and these changes, modifications and substitutions should all be covered by the scope of the present disclosure. Therefore, the scope of the present disclosure shall be subject to the scope of the claims.

What is claimed is:

1. A storage device, inserted into a control device, comprising:
a storage module;
an operating system module; and
a communication module,
wherein:
in response to receiving an insertion instruction, the operating system module is configured to load a system according to the insertion instruction to enter a working mode; and
the communication module is configured to remotely receive a to-be-written file from a terminal device and the operating system module is configured to write the to-be-written file into the storage module, to make the control device read a storage file stored in the storage module.

2. The storage device of claim 1, wherein:
in response that the to-be-written file is a control script, the operating system module is further configured to control the control device to load the control script and obtain a target file information; and
the communication module is further configured to send the target file information written into the storage module by the operating system module to the terminal device.

3. The storage device of claim 2, wherein:
the operating system module is further configured to recognize a use state of the control script; and
in response that the control script is in a used state, the operating system module is further configured to obtain the target file information.

4. The storage device of claim 3, wherein:
the communication module comprises a wireless communication module and a mobile communication module;
the communication module is further configured to determine a target remote communication module from the wireless communication module and the mobile communication module;
the communication module is further configured to remotely receive the to-be-written file from the terminal device through the target remote communication module;
the operating system module is further configured to determine a target operation instruction according to the control script and a preset operation instruction when the to-be-written file is the control script;
the operating system module is further configured to determine a target file type according to the target operation instruction and a preset file type; and
the operating system module is further configured to control the control device to load the control script according to the target file type, and obtain the target file information.

5. The storage device of claim 4, wherein the communication module is configured to determine a target remote communication module according to a network connection relationship between the terminal device and the control device.

6. The storage device of claim 1, wherein:
the communication module is further configured to remotely receive the to-be-written file from the terminal device; and
in response that the to-be-written file is an update file, the operating system module is configured to write a parameter information corresponding to the update file into the storage module, to make the control device read the parameter information stored in the storage module to update data of the storage device.

7. The storage device of claim 1, further comprising:
a universal serial bus (USB) interface;
wherein:
the operating system module is further configured to pack the storage file stored in the storage module according to a type of the USB interface and a data transmission format corresponding to the communication module to obtain a target data package; and
the communication module is further configured to send the target data package to the terminal device.

8. The storage device of claim 7, wherein the operating system module is configured to determine the data transmission format according to a communication protocol corresponding to the communication module.

9. The storage device of claim 1, wherein:
the communication module is further configured to remotely receive the to-be-written file from the terminal device via a current network signal, and
the operating system module is configured to write the to-be-written file into the storage module, to make the control device read the storage file stored in the storage module.

10. The storage device of claim 9, wherein:
when the current network signal connecting the terminal device to the storage device is stable, the communication module is configured to remotely receive the to-be-written file from the terminal device; and
when the current network signal is unstable, the communication module is configured to temporarily stop receiving the to-be-written file from the terminal device.

11. A method for controlling a storage device, applied to a system for controlling the storage device, wherein the system for controlling the storage device comprises a storage device, the storage device comprises a storage module, an operating system module and a communication module, and the method for controlling the storage device comprises following operations:
in response to receiving an insertion instruction, loading, by the operating system module, a system according to the insertion instruction to enter a working mode; and
remotely receiving, by the communication module, a to-be-written file from the terminal device, and writing, by the operating system module, the to-be-written file into the storage module, to make the control device read a storage file stored in the storage module.

12. The method of claim 11, wherein after the operation of remotely receiving, by the communication module, the to-be-written file from the terminal device, and writing, by the operating system module, the to-be-written file into the storage module, to make the control device read the storage file stored in the storage module, the method further comprises:
controlling, by the operating system module, the control device to load the control script and obtaining a target file information, in response that the to-be-written file is a control script; and
sending, by the communication module, the target file information written into the storage module by the operating system module to the terminal device.

13. The method of claim 12, wherein the operation of controlling, by the operating system module, the control device to load the control script and obtaining the target file information, in response that the to-be-written file is the control script comprises:
recognizing, by the operating system module, a use state of the control script; and
obtaining, by the operating system module, the target file information in response that the control script is in a used state.

14. The method of claim 13, wherein:
the communication module comprises a wireless communication module and a mobile communication module;
the operation of recognizing, by the operating system module, the use state of the control script; and obtaining, by the operating system module, the target file information in response that the control script is in the used state comprises:
determining, by the communication module, a target remote communication module from the wireless communication module and the mobile communication module;
remotely receiving, by the communication module, the to-be-written file from the terminal device through the target remote communication module;
determining, by the operating system module, a target operation instruction according to the control script and a preset operation instruction when the to-be-written file is the control script;
determining, by the operating system module, a target file type according to the target operation instruction and a preset file type; and
controlling, by the operating system module, the control device to load the control script according to the target file type, and obtaining the target file information.

15. The method of claim 11, wherein after the operation of remotely receiving, by the communication module, the to-be-written file from the terminal device, and writing, by the operating system module, the to-be-written file into the storage module, to make the control device read the storage file stored in the storage module, the method further comprises:
remotely receiving, by the communication module, the to-be-written file from the terminal device; and
in response that the to-be-written file is an update file, writing, by the operating system module, a parameter information corresponding to the update file into the storage module, to make the control device read the parameter information stored in the storage module to update data of the storage device.

16. The method of claim 11, wherein:
the storage device further comprises a USB interface;
after the operation of remotely receiving, by the communication module, the to-be-written file from the terminal device, and writing, by the operating system module, the to-be-written file into the storage module, to make the control device read the storage file stored in the storage module, the method further comprises:
packing, by the operating system module, the storage file stored in the storage module according to a type of the USB interface and a data transmission format corresponding to the communication module to obtain a target data package; and
sending, by the communication module, the target data package to the terminal device.

17. The method of claim 11, wherein the operation of remotely receiving, by the communication module, the to-be-written file from the terminal device, and writing, by the operating system module, the to-be-written file into the storage module, to make the control device read the storage file stored in the storage module further comprises:
remotely receiving, by the communication module, the to-be-written file from the terminal device via a current network signal, and writing, by the operating system module, the to-be-written file into the storage module, to make the control device read the storage file stored in the storage module.
